(19) United States
(12) Patent Application Publication
(10) Pub. No.: US 2008/0311475 A1
(43) Pub. Date: Dec. 18, 2008

(54) CHARGING A LITHIUM ION BATTERY

(75) Inventors: Veselin Manev, Reno, NV (US); John Shelburne, Sparks, NV (US)

Correspondence Address: MORRISON & FOERSTER LLP, 425 MARKET STREET, SAN FRANCISCO, CA, 94105-2482, US

(73) Assignee: ALTAIRNANO, INC., Reno, NV (US)

(21) Appl. No.: 12/139,414

(22) Filed: Jun. 13, 2008

Related U.S. Application Data
(60) Provisional application No. 60/943,813, filed on Jun. 13, 2007.

(51) Int. Cl. H01M 4/38; H02J 7/04

(52) U.S. Cl. 429/231.5; 320/155

(57) ABSTRACT

A lithium titanate-based electrochemical cell is charged by adding an electrolytic solution to the lithium titanate-based electrochemical cell to form an activated electrochemical cell. Current is provided to the activated electrochemical cell to charge the activated electrochemical cell to a first state of charge for a first period of time. The electrochemical cell is further charged to a second state of charge for a second period of time at a temperature range of 40° C. to 120° C.

### CROSS REFERENCE TO RELATED APPLICATION

This application claims priority to U.S. Provisional Patent Application Ser. No. 60/943,813 filed on Jun. 13, 2007, which is incorporated herein by reference in its entirety for all purposes.

### BACKGROUND

1. Field

The present application generally relates to charging a lithium ion battery. The present application more specifically relates to charging a lithium titanate-based electrochemical cell such that the electrochemical cell exhibits improved properties.

2. Related Art

Lithium-ion cells containing a liquid electrolyte typically include a graphite anode and a lithium metal oxide or lithium metal phosphate cathode. Such cells are activated by filling them with electrolyte. They are subsequently “formed”—i.e., the anode and cathode surfaces are prepared to achieve desirable cell performance. Anode surface preparation involves coating of the electrode with a Solid Electrolyte Interface (i.e., SEI) that is conductive to lithium ions but is not electronically conductive. SEI formation generally occurs after application of one or more consecutive charge/discharge cycles.

Fong et al. discusses a one-cycle formation procedure. See “Studies of Lithium Intercalation into Carbons Using Nonaqueous Electrochemical Cells,” J. Electrochem. Soc. 137: 2009, 1990. A cell is filled with electrolyte and subsequently sealed. The sealed cell is charged with a current of 0.14 mA/cm² for 25 to 40 hours, followed by cell discharge at about 0.1 mA/cm².

U.S. Pat. No. 6,790,243 discloses a claimed improvement of the Fong formation procedure. A cell is filled with electrolyte and allowed to stand for a period of time. It is then charged at a current density of about ¼ mA/cm² for at least an hour and allowed to stand open-circuited for at least an hour. A second charge is performed at a current density significantly greater than the first, until the cell reaches desired cell capacity. Gases are vented; the cell is discharged at a relatively high current density; and, the lithium-ion cell is sealed.

It has been found that the reported cell formation procedures are disadvantageous for cells containing a lithium titanate-based negative electrode.

### SUMMARY

In one exemplary embodiment, a lithium titanate-based electrochemical cell is charged by adding an electrolytic solution to the lithium titanate-based electrochemical cell to form an activated electrochemical cell. Current is provided to the activated electrochemical cell to charge the activated electrochemical cell to a first state of charge for a first period of time. The electrochemical cell is further charged to a second state of charge for a second period of time at a temperature range of 40° C. to 120° C.

### DESCRIPTION OF DRAWING FIGURES

FIG. 1 depicts an exemplary lithium titanate-based electrochemical cell.

FIG. 2 is a flow chart of an exemplary charging process for charging the lithium titanate-based electrochemical cell depicted in FIG. 1.

FIG. 3 is a graph depicting a cycle life test performed at 25° C. and 100% depth of discharge (DOD) for a lithium titanate-based battery.

FIG. 4 is a graph depicting self discharge of a lithium titanate-based battery.

FIG. 5 is a graph depicting electrochemical impedance spectroscopy (EIS) measurements of a lithium titanate-based battery.

### DETAILED DESCRIPTION

The following description generally relates to charging a lithium ion battery. The following description more specifically relates to charging a lithium titanate-based electrochemical cell such that the electrochemical cell exhibits improved properties. The following description further relates to an electrochemical cell charged by such a process.

### 1. DEFINITIONS

In the following description, the phrase “state of full charge” is used to mean that the cell is charged to its predetermined cut-off charge voltage. The cell voltage corresponding to the state of full charge is defined as the cell open cell voltage (OCV) after one hour rest immediately following the full charge step. By “state of overcharge” it is meant that the cell voltage is kept higher than the cell OCV voltage at full charge state.

### 2. PREPARATION OF ELECTROMECHANICAL CELL

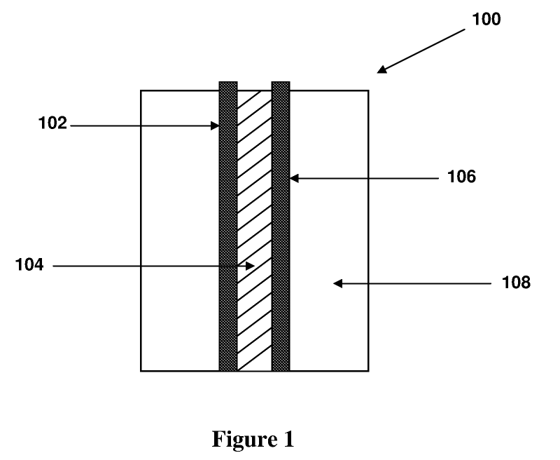

An exemplary embodiment of a lithium titanate-based electrochemical cell 100 is depicted in FIG. 1. Lithium titanate-based electrochemical cell 100 includes a positive electrode 102, a separator 104, a lithium titanate-based negative electrode 106, and an electrolytic solution 108.

Positive electrode 102 can be formed by preparing a positive electrode mixture typically containing active material, a conducting agent, and a binder. The positive electrode mixture is dissolved in a solvent to provide a paste, which is applied to a first current collector to form a coating. A small portion of the first current collector is left uncoated in order for a lead to be connected to it. The coating is dried and pressed with or without heating to form positive electrode 102.

Lithium titanate-based negative electrode 106 can be formed by preparing a negative electrode mixture typically containing lithium titanate spinel, a conducting agent, and a binder. The negative electrode mixture is dissolved in a solvent to provide a paste, which is applied to a second current collector to form a coating. A small portion of the second current collector is left uncoated in order for a lead to be connected to it. The coating is dried and pressed with or without heating to form lithium titanate-based negative electrode 106.

In some variations, the first current collector and second current collector have two sides. The positive electrode material and negative electrode material may be applied to both sides.

A positive electrode lead and a negative electrode lead are attached to the uncoated parts of the first current collector of positive electrode 102 and second current collector of lithium titanate-based negative electrode 106, respectively. Separator 104 is interposed between positive electrode 102 and lithium titanate-based negative electrode 106. Separator 104 is fixed, typically with tape, to provide an electrode group. The electrode group is inserted into a battery container (e.g., stainless steel can or foil pouch).

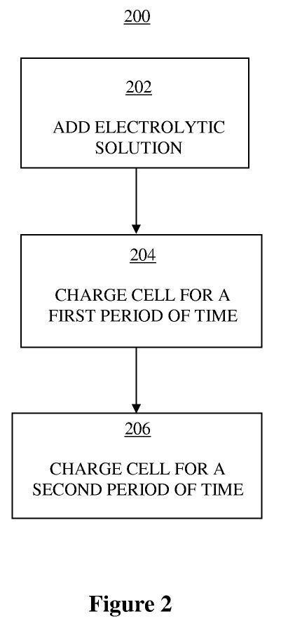

FIG. 2 depicts an exemplary charging process 200 of charging lithium titanate-based electrochemical cell 100 depicted in FIG. 1. In step 202, an electrolytic solution is added to the cell. In particular, with reference to FIG. 1, electrolytic solution 108 is poured into the battery container containing the electrode group, and the container is sealed. In some variations, the container is hermetically sealed. This provides an activated electrochemical cell ready to be charged.

Solution 108 typically contains a mixed solvent in which a lithium salt is dissolved. Examples of solvents which may be used include ethylene carbonate (EC), ethylmethyl carbonate (EMC), propylene carbonate (PC), butylene carbonate (BC), vinylene carbonate (VC), diethylene carbonate (DEC), dimethylene carbonate (DMC), γ-butyrolactone, sulfolane, methyl acetate (MA), methyl propionate (MP), and methylformate (MF). Examples of lithium salts include LiBF₄, LiPF₆, LiAsF₆, LiClO₄, LiSbF₆, LiCF₃SO₃, and LiN(CF₃ SO₂)₂.

With reference to FIG. 2, in step 204, after the electrochemical cell is activated, a current is provided to the activated electrochemical cell to charge the cell to a first state of charge. The timeframe between cell activation and this first charge step does not affect cell performance and may range from several minutes to several months. In some variations, the cell is kept at OCV after charging to a first state of charge for a period of time. In some variations, the period of time may range from approximately 0.1 to 24 hours. Using a longer period for this step, however, does not negatively affect the properties of the cell.

In step 206, after step 204, the cell is charged again to a second state of charge. It is typically charged and kept at the second state of charge at an elevated temperature for approximately 0.25 or 0.5 hour. In some variations, the second state of charge is maintained at an elevated temperature for approximately 0.75 or 1 hour. In some variations, the second state of charge is maintained at an elevated temperature for a period of time ranging from approximately 0.25 to 48 hours, 0.5 to 48 hours, or 1 to 48 hours. Alternatively, the cell may be charged to the second state of charge at ambient temperature and then maintained at the second state of charge at an elevated temperature for a period of time.

The charging and maintaining of the cell at a second state of charge typically occurs at a temperature ranging from approximately 40° C. to 120° C. In some variations, the charging is carried out at a temperature ranging from approximately 60° C. to 120° C., 60° C. to 100° C., or 70° C. to 90° C. In some variations, the charging is carried out at a temperature ranging from approximately 80° C. to 85° C. Alternatively, the cell may be charged to the second state of charge at ambient temperature and then maintained at the second state of charge at a temperature ranging from approximately 40° C. to 120° C. for a period of time.

After charging, an out-gassing step may be performed. This optional step typically involves the application of vacuum to the seal, which removes generated gases, followed by hermetic sealing or resealing of the electrochemical cell.

In some variations, the first and/or second state of charge is a state of overcharge having a voltage. In some variations, the voltage may be greater than the open cell voltage of the electrochemical cell at a state of full charge by approximately 10 mV. In some variations, the voltage may be greater than the open cell voltage of the electrochemical cell at a state of full charge by approximately 50 mV.

With reference again to FIG. 1, cell 100 has a capacity that is controlled by the capacities of lithium titanate-based negative electrode 106 and positive electrode 102. In particular, lithium titanate-based negative electrode 106 and positive electrode 102 each have a capacity. In some variations, the ratio of the capacity of lithium titanate-based negative electrode 106 to the capacity of positive electrode 102 is approximately 1.05. In some variations, the ratio is approximately 1.10 or 1.15. In some variations, the ratio is approximately 1.20 or 1.25.

An electrochemical cell, such as cell 100, charged using exemplary charging process 200 (FIG. 2) typically exhibits improved properties relative to a cell that is charged using a conventional charging process. For example, if one takes two identical, lithium titanate-based cells and charges one according to exemplary charging process 200 (FIG. 2) while charging the other with a conventional charging process, the cell charged using exemplary charging process 200 (FIG. 2) typically exhibits improved cycle life, self-discharge profile and power retention. For instance, a cell charged using exemplary charging process 200 (FIG. 2) typically retains at least 80 percent of its capacity for at least twice the number of cycles as compared to a cell charged using a conventional charging process. In some variations, a cell charged using exemplary charging process 200 (FIG. 2) retains at least 80 percent of its capacity for at least three or four times the number of cycles as compared to a cell charged by a conventional charging process. In some variations, a cell charged using exemplary charging process 200 (FIG. 2) retains at least 80 percent of its capacity for at least five, seven or ten times the number of cycles as compared to a cell charged by a conventional charging process. In some variations, charged lithium titanate-based electrochemical cell 100, which was charged using exemplary charging process 200 (FIG. 2), loses no more than 4.25% cell voltage after 100 hours of self discharge. In some variations, the charged lithium titanate-based electrochemical cell 100, which was charged using exemplary charging process 200 (FIG. 2), loses no more than 5% cell voltage after 100 hours of self discharge.

### 3. EXAMPLE 1

An electrochemical cell was assembled. The negative electrode was prepared from nano Li₄Ti₅O₁₂ and the positive electrode was prepared from LiCoO₂.

The negative electrode was prepared using the following steps: mixing the Li₄Ti₅O₁₂ with 10% carbon black and 8% PVDF binder dissolved in NMP solvent to form a slurry; the slurry was spread on aluminum foil and heated to evaporate the NMP solvent; the dry electrode was calendared and cut into a rectangular sample electrode having a 2″ by 3″ size of about 38 cm².

The positive electrode was prepared with LiCoO₂ using the same procedure described for preparation of the negative electrode.

The two prepared electrodes were placed inside in a soft pack electrochemical cell with EC:EMC/LiPF₆ electrolyte.

In accordance with exemplary charging process 200 (FIG. 2), after activation of the cell with the electrolyte, the cell was charged to 2.8 V than kept at OCV for about 16 hours. Then the cell was put in a preheated furnace at 80° C., charged again inside the furnace to 2.8 V, and kept in the furnace at this voltage for about 8 hours. Next, the cell was cooled down to ambient temperature and degassed. Finally, a cycling test was performed at 25° C.

### 4. COMPARATIVE EXAMPLE 1

An electrochemical cell with the same negative and positive electrodes as in Example 1 was prepared according to the procedure described in Example 1. The cell was activated with the same electrolyte as in Example 1. After the activation, the cell was charged with three consecutive charge/discharge cycles, which is a conventional charging process for general lithium ion batteries. The cell was then degassed and a cycling test was performed at 25° C.

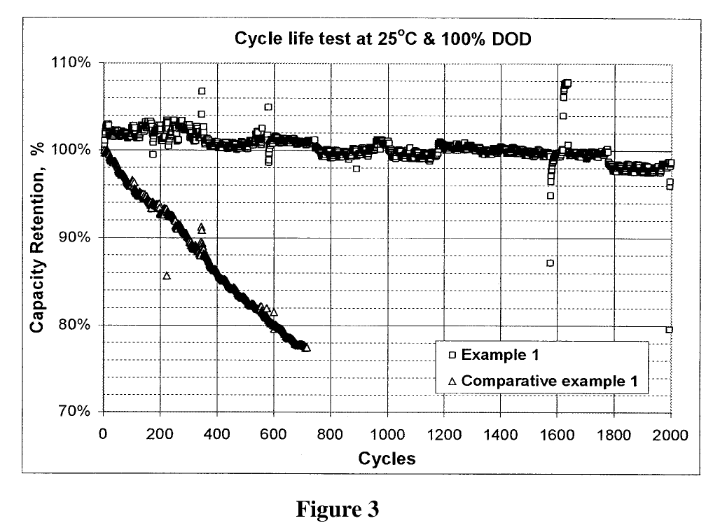

The comparison of cycling performance of the cells formed by the two different charging processes is shown in FIG. 3. As displayed in FIG. 3, the cell charged according to exemplary charging process 200 (FIG. 2) does not change its capacity during the first 600 cycles (data points indicated using squares in FIG. 3 and noted as Example 1 in the legend), while the cell charged according to the conventional charging process lost about 20% of its capacity in the same number of cycles (data points indicated using triangles in FIG. 3 and noted as Comparative example 1 in the legend). FIG. 3 also shows that after 2000 cycles the cell charged according to exemplary charging process 200 (FIG. 2) lost only 2 to 3% of its initial capacity.

### 5. EXAMPLE 2

An electrochemical cell was prepared. The negative electrode was prepared from nano Li₄Ti₅O₁₂ and the positive electrode was prepared from LiNi_{1/3}Co_{1/3}Mn_{1/3}O₂ using the same procedure described in Example 1.

In accordance with exemplary charging process 200 (FIG. 2), after cell activation with the same electrolyte described in Example 1, the cell was charged to 2.7 V and kept at its OCV for about 8 hours. Then the cell was charged again to 2.7 V and put in a preheated furnace at 80° C. After that, the cell was cooled down to ambient temperature and degassed. Then the cell was charged again to 2.7 V and the OCV was monitored over time for calculation of the cell's self-discharge rate.

### 6. COMPARATIVE EXAMPLE 2

An electrochemical cell with the same negative electrode as in Example 2 and the same positive electrode LiNi_{1/3}Co_{1/3}Mn_{1/3}O₂ as in Example 2 was prepared according to procedure described in Example 1. After the activation, the cell was charged using a conventional charging process with three consecutive charge/discharge cycles as in Comparative Example 1. Then, the cell was degassed, charged to 2.7 V and the OCV was monitored over time as an indication of cell self-discharge rate.

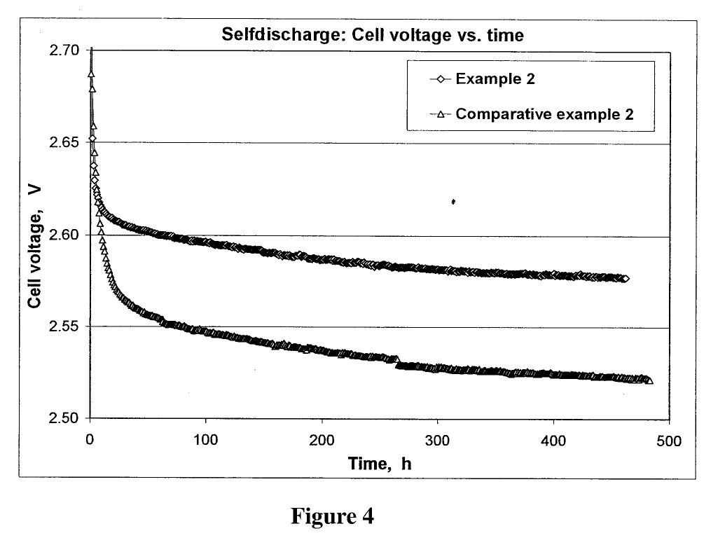

The comparison of the self-discharge rate of the cells formed by the two different charging processes is shown in FIG. 4. The cell voltage decay of the cell charged according to exemplary charging process 200 (FIG. 2) (data points indicated using diamonds in FIG. 4 and noted as Example 2 in the legend) is significantly lower than the voltage decay of the cell charged using a conventional charging process (data points indicated using triangles in FIG. 4 and noted as Comparative example 2 in the legend). Furthermore, as displayed in FIG. 4, the cell charged using the conventional charging process reaches 2.58 V corresponding to a 98% state of charge after about 16 hours, while the cell charging according to exemplary charging process 200 (FIG. 2) reaches said voltage and state of charge after about 480 hours. This suggests that exemplary charging process 200 (FIG. 2) suppresses the self-discharge rate of the cell by a factor of about 30.

### 7. EXAMPLE 3

An electrochemical cell was prepared. The negative electrode was prepared from nano Li₄Ti₅O₁₂ and the positive electrode was prepared from LiMn₂O₄ using the same procedure described in Example 1.

In accordance with exemplary charging process 200 (FIG. 2), after cell activation with the same electrolyte described in Example 1, the cell was charged to 2.9 V and kept at its OCV for about 6 hours. Then the cell was charged again to 2.9 V and put in a preheated furnace at 80° C. After that, the cell was cooled down to ambient temperature and degassed. Next, the cell was discharged to 70% of its state of charge (SOC) and EIS impedance measurements were conducted in the frequency range of 10³-10⁻² Hz with 2 mV amplitude.

### 8. COMPARATIVE EXAMPLE 3

An electrochemical cell with the same negative electrode as in Example 3 and the same positive electrode LiMn₂O₄ as in Example 3 was prepared according to procedure described in Example 1. After the activation, the cell was charged using a conventional charging process with three consecutive charge/discharge cycles as in Comparative Example 1. Then, the cell was degassed, discharged to 70% of its state of charge (SOC) and EIS impedance measurements were conducted in the frequency range of 10³-10⁻² Hz with 2 mV amplitude, as in Example 3.

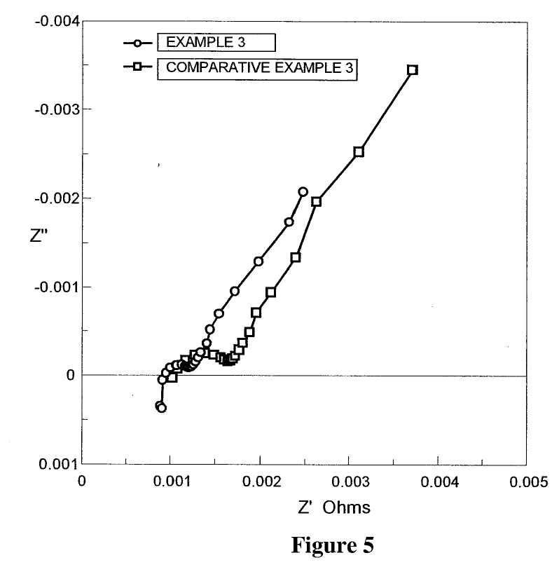

The comparison of the EIS impedance of the cells charged by the two different charging processes is shown in FIG. 5. As displayed, the impedance of the cell charged using exemplary charging process 200 (FIG. 2) (data points indicated using circles in FIG. 5 and noted as EXAMPLE 3 in the legend) is about 50% lower than the impedance of the cell charging using a conventional charging process (data points indicated using squares in FIG. 5 and noted as COMPARATIVE EXAMPLE 3 in the legend).

Although the methods and apparatus described herein have been described in connection with some variations, it is not intended to be limited to the specific form set forth herein. Rather, the scope of the methods and apparatus described herein is limited only by the claims. Additionally, although a feature may appear to be described in connection with particular variations, one skilled in the art would recognize that various features of the described variations may be combined in accordance with the methods and apparatus described herein.

Furthermore, although individually listed, a plurality of means, elements or method steps may be implemented by, for example, a single apparatus or method. Additionally, although individual features may be included in different claims, these may be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof, unless otherwise expressly stated, should be construed as open ended as opposed to limiting. As examples of the foregoing: the term “including” should be read to mean “including, without limitation” or the like; the terms “example” or “some variations” are used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of methods and apparatus described herein may be described or claimed in the singular, the plural is contemplated to be within the scope thereof unless limitation to the singular is explicitly stated. The presence of broadening words and phrases such as “one or more,” “at least,” “but not limited to,” “in some variations” or other like phrases in some instances shall not be read to mean that the narrower case is intended or required in instances where such broadening phrases may be absent.

We claim:

1. A method of charging a lithium titanate-based electrochemical cell, the method comprising:
a) adding an electrolytic solution to the lithium titanate-based electrochemical cell to form an activated electrochemical cell;
b) providing current to the activated electrochemical cell to charge the activated electrochemical cell to a first state of charge for a first period of time; and
c) further charging the electrochemical cell to a second state of charge for a second period of time at a temperature range of 40° C. to 120° C. to form a charged lithium titanate-based electrochemical cell.

2. The method of claim 1, further comprising:
removing gases from the lithium titanate-based electrochemical cell.

3. The method of claim 1, further comprising:
maintaining the activated electrochemical cell at open cell voltage for period of time ranging from 0.1 to 24 hours between steps b) and c).

4. The method of claim 3, wherein the second period of time ranges from 0.25 to 48 hours.

5. The method of claim 4, wherein the second period of time ranges from 0.25 to 1 hour.

6. The method of claim 1, wherein step c) is performed at a temperature range from 60° C. to 120° C.

7. The method of claim 6, wherein step c) is performed at a temperature range from 70° C. to 90° C.

8. The method of claim 7, wherein step c) is performed at a temperature range from 80° C. to 85° C.

9. The method of claim 1, wherein the electrochemical cell comprises a negative electrode and a positive electrode, and wherein the electrochemical cell has a capacity, the capacity controlled by the negative electrode.

10. The method of claim 9, wherein the negative electrode has a negative electrode capacity and the positive electrode has a positive electrode capacity, and wherein the negative electrode capacity to positive electrode capacity ratio is at least 1.05.

11. The method of claim 10, wherein the negative electrode capacity to positive electrode capacity ratio is at least 1.10.

12. The method of claim 10, further comprising:
maintaining the activated electrochemical cell at open cell voltage for 0.1 to 24 hours between steps b) and c), wherein the second period of time ranges from 0.25 to 48 hours, and wherein step c) is performed at a temperature range from 60° C. to 120° C.

13. The method of claim 1, wherein the first and/or second state of charge is a state of overcharge having a voltage, the voltage greater than an open cell voltage of the electrochemical cell at a state of full charge by at least 10 mV.

14. The method of claim 1, wherein the first and/or second state of charge is a state of overcharge having a voltage, the voltage greater than an open cell voltage of the electrochemical cell at a state of full charge by at least 50 mV.

15. The method of claim 1, wherein the charged lithium titanate-based electrochemical cell loses no more than 4.25% cell voltage after 100 hours of self discharge.

16. The method of claim 1, wherein the charged lithium titanate-based electrochemical cell loses no more than 5% cell voltage after 100 hours of self discharge.

17. A method of charging a lithium titanate-based electrochemical cell, the method comprising:
a) adding an electrolytic solution to the lithium titanate-based electrochemical cell to form an activated electrochemical cell;
b) providing current to the activated electrochemical cell to charge the activated electrochemical cell to a first state of charge for a first period of time;
c) further charging the electrochemical cell to a second state of charge; and
d) maintaining the electrochemical cell at a temperature range of 40° C. to 120° C. for a second period of time to form a charged lithium titanate-based electrochemical cell.

18. A charged lithium titanate-based electrochemical cell comprising:
a lithium titanate-based negative electrode;
a positive electrode;
an electrolytic solution; and
a separator, wherein the charged lithium titanate-based electrochemical cell was charged to a first state of charge for a first period of time, and wherein the charged lithium titanate-based electrochemical cell was further charged to a second state of charge for a second period of time at a temperature range of 40° C. to 120° C.

19. The charged lithium titanate-based electrochemical cell of claim 18, wherein the charged lithium titanate-based electrochemical cell loses no more than 4.25% cell voltage after 100 hours of self discharge.

20. The charged lithium titanate-based electrochemical cell of claim 18, wherein the charged lithium titanate-based electrochemical cell loses no more than 5% cell voltage after 100 hours of self discharge.
